(19) United States
(12) Patent Application Publication
(10) Pub. No.: US 2014/0107925 A1
(43) Pub. Date: Apr. 17, 2014

(54) SYSTEMS AND METHODS FOR TRACKING A SET OF EXPERIMENTS

(71) Applicant: FLYBERRY CAPITAL LLC, Cambridge, MA (US)

(72) Inventors: Tsung-Yao Chang, Cambridge, MA (US); Tsung-Hsiang Chang, Medford, MA (US)

(73) Assignee: Flyberry Capital LLC, Cambridge, MA (US)

(21) Appl. No.: 13/649,940

(22) Filed: Oct. 11, 2012

(51) Int. Cl. G06F 19/00; G01W 1/00

(52) U.S. Cl. 702/3; 702/123; 702/116

(57) ABSTRACT

The present solution provides a new tool to facilitate the tracking of experiments and development of data-driven algorithms. The tool may obtain algorithms, parameters and data sets to execute one or more experiments to produce an outcome. The tool may identify differences between two or more experiments, such as differences in parameters, algorithms, or data sets to facilitate identifying the optimal combination of algorithms or parameters.

A portion of the disclosure of this patent document contains material which is subject to copyright protection. The copyright owner has no objection to the facsimile reproduction by anyone of the patent document or the patent disclosure, as it appears in the file or records of the Patent and Trademark Office, but otherwise reserves all copyright rights whatsoever.

### FIELD OF THE DISCLOSURE

This disclosure generally relates to systems and methods for tracking a set of experiments. In particular, this disclosure relates to systems and methods for identifying information about one or more experiments, executing the one or more experiments, storing data related to the execution of the one or more experiments, and identifying differences between the one or more experiments.

### BACKGROUND OF THE DISCLOSURE

Developers of data-driven algorithms may conduct numerous experiments to facilitate development of an algorithm that provides a desired result. Experiments may include various combinations of algorithms, parameters, and input data. Developers maintain a separate lab notebook for each experiment to write down the parameters and results corresponding to each run of the experiment.

When developing numerous algorithms and conducting numerous experiments for each algorithm, it is a challenge to determine, maintain and visualize information about each experiment or algorithm.

### BRIEF SUMMARY OF THE DISCLOSURE

The present solution provides a new tool for tracking a set of experiments. The tool allows a developer to identify a plurality of aspects of an experiment, including, e.g., algorithms, parameters, and data sets, execute the experiments to produce outcomes, and identify, store, and visualize differences between each experiment.

In some embodiments, the tool automatically determines the data set, the parameters, and the algorithms used in each run of the experiment. The tool may record this information and the outcome of the experiment in a database. Using this information, the tool may highlight the differences between data sets, parameters, algorithms, and outcomes between any two experiments. This information may be used to determine an optimal combination of parameters, data sets, and algorithms.

In some embodiments, the tool may re-run an experiment with a parameter, data set, and algorithm recorded in the database. The tool may also provide for annotation of one or more aspects of the experiment. For example, a developer may insert, attach, or otherwise provide a textual note corresponding to an aspect of an experiment.

In some aspects, the present solution is directed to a method for tracking a set of experiments. The method includes identifying an algorithm and one or more parameters by a tool executing on a device. The tool may identify the one or more parameters and algorithm for each of several experiments of a set of experiments to be executed. The set of experiments may facilitate identifying a correlation between a first set of one or more events of a first data set and a second set of one or more events of a second data set. The tool may execute the set of experiments to produce an outcome for each of the experiments and store an electronic record of the execution. The electronic record may include at least one of the algorithm, the one or more parameters, the first data set, the second data set, and the outcome. The method may include identifying the one or more differences between the experiments.

In some embodiments, the method includes executing the set of experiments within a predetermined time period. In some embodiments, the method includes executing at least two or more of the plurality of experiments concurrently.

In some embodiments, the method includes determining a level of correlation. The level of correlation may be based on a classification identifier, a frequency of events, and an event time.

In some embodiments the method may include executing a second set of experiments by the tool. The second set of experiments may include several experiments and executing the second set of experiments may produce one or more outcomes for each of the several. The method may further include identifying one or more differences between the first set of experiments and the second set of experiments.

In some embodiments, the method includes selecting a first subset of the first data set and a second subset of the second data set. The method may also include executing the set of experiments based on the first and second subsets.

In some embodiments, the method includes quantifying at least one of the first set of one or more events and at least one of the second set of one or more events. The method may quantify the events using a classification identifier and an event time.

In some embodiments, the method includes determining at least one of a keyword match, semantic concept, or metric by the tool. The determination may be based on at least one of the first and second data sets. The method may also include assigning, by the tool, a classification identifier to at least one of the one or more events corresponding to the determination.

In some embodiments, the method includes selecting at least one of the algorithm and one or more parameters corresponding to one of the plurality of experiments. The tool may make the selection based on an outcome threshold. The method may also include executing, by the tool, a second set of experiments comprising at least one of the selected algorithm and the selected one or more parameters.

In some embodiments, at least one of the first data set and the second data set includes streaming data. The streaming data may include at least one of online social network data, financial instrument data, news data, sensor data, and weather data.

In some embodiments, the method includes receiving an annotation corresponding to an experiments. The tool may receive the annotation by a user interface and store the annotation in an electronic record.

In some aspects, the present solution is directed to a system for tracking a set of experiments. The system may include a tool executing on a device. The tool may execute each of a plurality of experiments of a set of experiments to identify a correlation between a first set of one or more events of a first data set and a second set of one or more events of a second data set. For each of several experiments to be executed, the tool may identify an algorithm and one or more parameters. The tool may execute the set of experiments to produce an outcome for each of the plurality of experiments. The tool may include a database that stores an electronic record of the execution of the set of experiments. The electronic record may include at least one of the algorithm, the one or more parameters, the first data set, the second data set, and the outcome. The tool may identify one or more differences between the plurality of experiments.

In some embodiments, the tool executes the set of experiments within a predetermined time period. In some embodiments, the tool executes at least two or more of the plurality of experiments concurrently.

In some embodiments, the tool determines a level of correlation. The level of correlation may be based, e.g., on a classification identifier, a frequency of events, and an event time.

In some embodiments, the tool executes a second set of experiments that includes a second plurality of experiments. The second set of experiments may produce one or more outcomes for each of a second plurality of experiments. The tool may also identify one or more differences between the first set of experiments and the second set of experiments.

In some embodiments, the tool selects a first subset of the first data set and a second subset of the second data set, and executes the set of experiments based on the first and second subsets.

In some embodiments, the tool quantifies at least one of the first set of one or more events and at least one of the second set of one or more events. The quantification may include a classification identifier and an event time.

In some embodiments, the tool determines at least one of a keyword match, semantic concept, or metric. The tool may make the determination based on at least one of the first and second data sets. The tool may assign a classification identifier to at least one of the one or more events corresponding to the determination.

In some embodiments, the tool selects at least one of the algorithm and one or more parameters corresponding to one of the plurality of experiments. The tool may make the selection based on an outcome threshold. The tool may also execute a second set of experiments that includes at least one of the selected algorithm and the selected one or more parameters.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein.

FIG. 2 is an embodiment of a system comprising an experiment tracking tool.

FIG. 3 is a flow diagram depicting an embodiment of a method of using the experiment tracking tool.

FIG. 4. is an illustration of systems and methods of tracking experiments.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein.
Section B describes embodiments of systems and methods for an experiment tracking tool.

### A. Computing and Network Environment

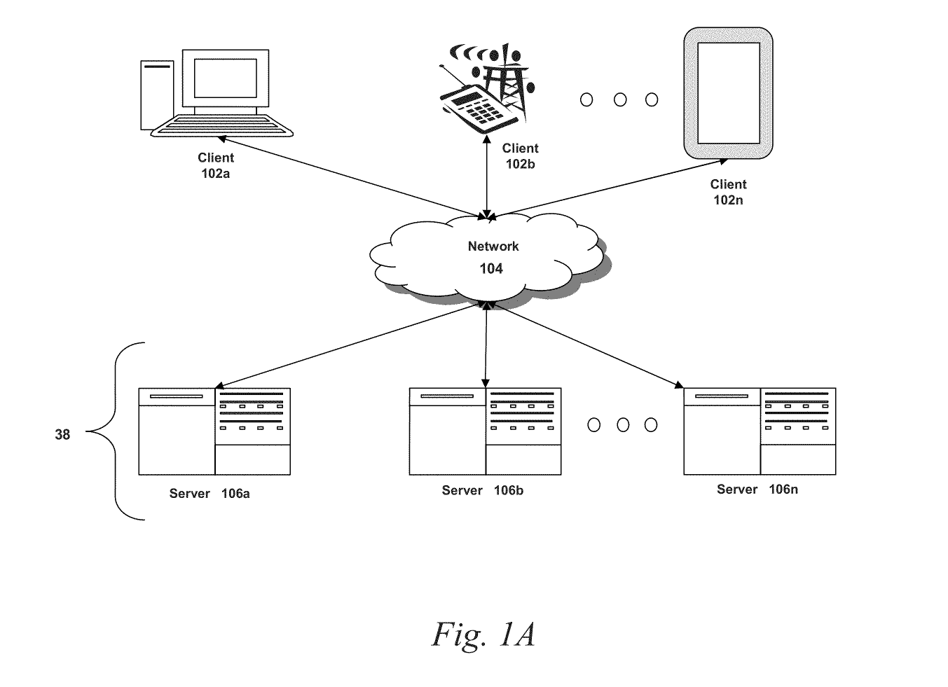

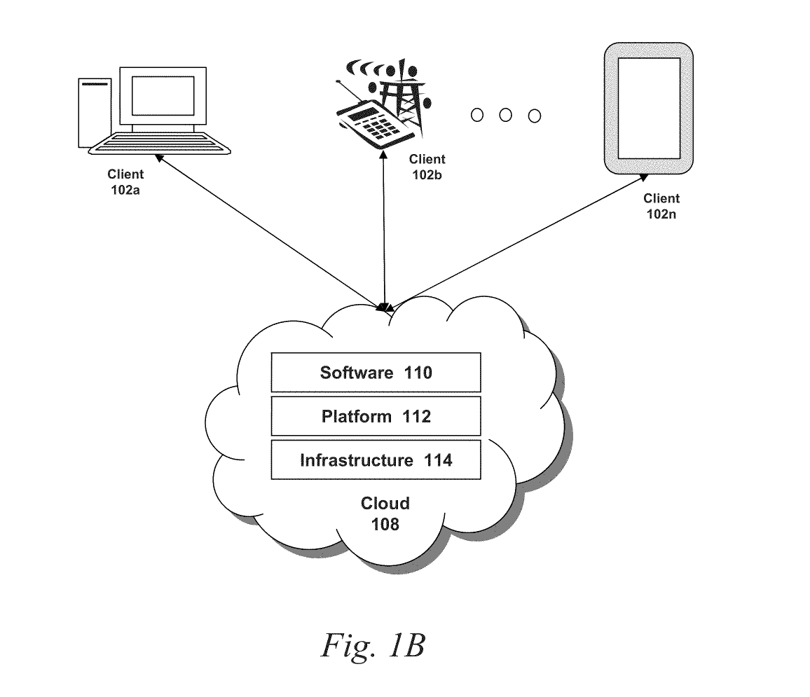

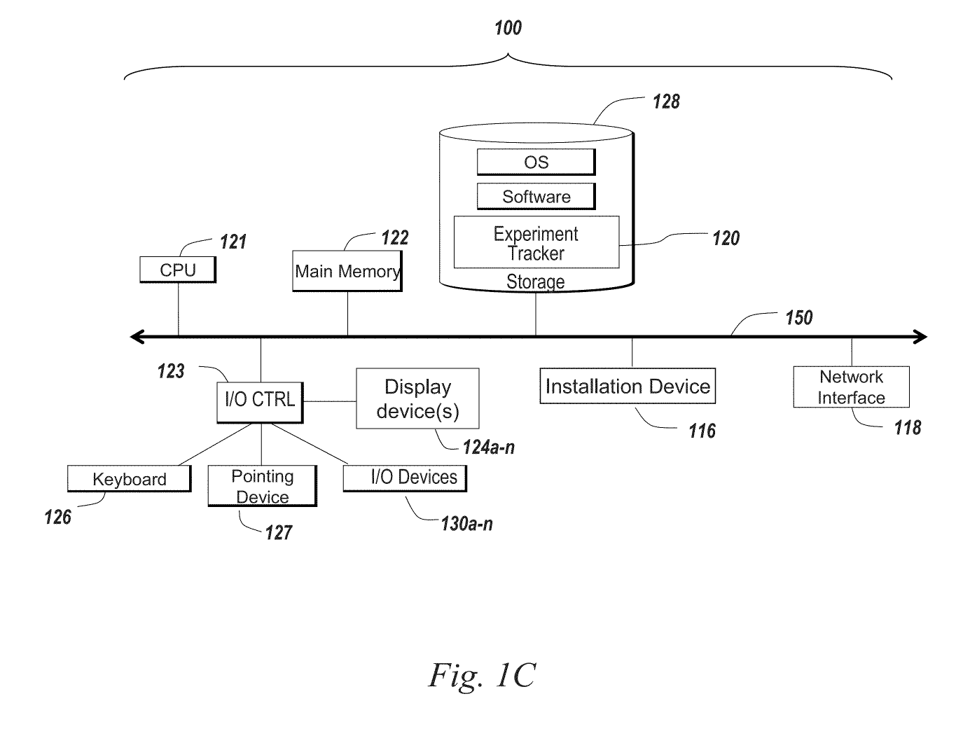

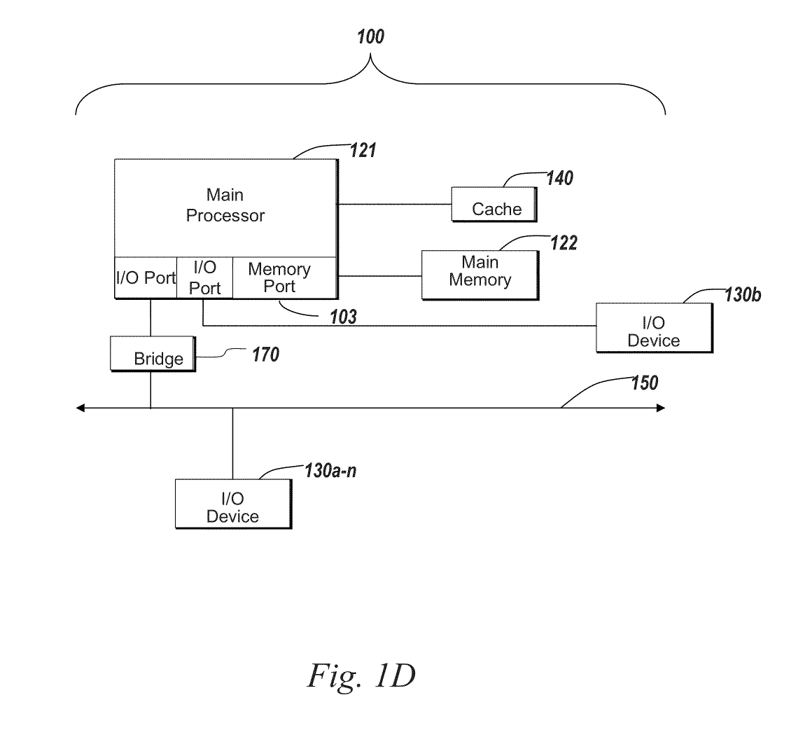

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of an experiment tracker system 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WIL Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the experiment tracker system. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as a installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Experiment Tracking Tool

Systems and method of the present solution are directed to an experiment tracking tool (“ETT” or “tool”) that facilitates the development of data-driven algorithms. The tool facilitates development of data-driven algorithms by tracking a set of experiments. Each experiment may include one or more algorithms, one or more parameters, and one or more data sets. The tool may run multiple experiments or repetitive experiments to determine a combination of parameters of an algorithm that provide for an optimal result.

In an illustrative example, the tool may facilitate the development of an algorithm that may be used for buying or selling a financial instrument, such as a stock trading algorithm. For example, an algorithm may be developed to identify a relationship between two events, such as the relationship between a natural phenomenon (e.g., a hurricane, earthquake, tornado, twister, solar storm, eclipse, etc.) occurring in a geographic region and changes in stock price of one or more companies. To identify and quantify this relationship, the tool may receive a data set that includes information about natural occurrences (e.g., data from a global seismic sensor network, news data, historical weather data, historical earthquake data). The tool may identify events in the natural occurrence data set, such as hurricanes, earthquakes or droughts, and classify those events (e.g., classification identifier, severity, category, metric, casualty, damage, etc.).

The tool may also receive a data set that includes financial instrument data (e.g., a company identifier, attributes about the company, information about historical and/or current stock prices on a public stock exchange). The tool may analyze the financial instrument data set to classify the companies. The companies may be classified by industry type (e.g., agriculture, automobiles, consumer electronics, manufacturing, service industry), geographic location, size of company, or market (geographic, online, demographics). The tool may identify events in the financial instrument data set, such as a high stock price, low stock price, volume, rate of change of stock price, etc.

The tool may receive one or more algorithms that facilitate identifying events in the data sets, classifying events and determining the relationship between one event and another event. For example, the tool may correlate events in one data set with events in another data set. In some embodiments, the tool may correlate events based on one or more of a classification identifier, time, geographic location, semantic concepts, keywords, or a statistical analysis.

Further to the stock trading example, the outcome of the algorithm may indicate that a certain natural occurrence in a certain geographic area occurring at a certain time may be related to a quantifiable change in the stock price of a specific company on the New York Stock Exchange. For example, a category 5 hurricane in the Gulf Coast may result in 70% of the stock prices going down, 20% going up, and 10% staying the same over a predetermined period of time. The tool may identify an action to take (e.g., buy or sell stock), on what to take the action (e.g., name of company or ticker symbol), when to take the action (e.g., immediately after an identified event occurs), and predicts the performance (e.g., amount of increase in stock price).

The systems and method of the experiment tracking tool provide a plurality of benefits. For example, the tool allows an algorithm developer to evaluate multiple experiments quickly and easily. In some embodiment, the algorithm developer can objectively evaluate each experiment using the same criteria and highlighting the differences between experiments.

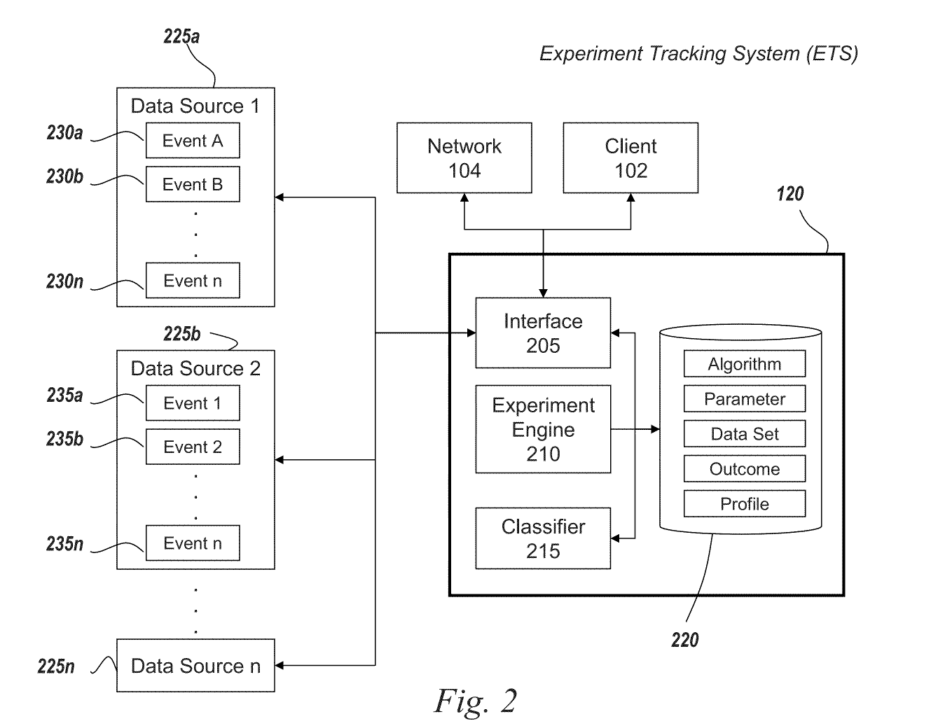

Referring to FIG. 2, an embodiment of a system comprising an experiment tracking tool 120 is depicted. In brief overview, the tool 120 receives, via interface 205, user input and data from network 104, client 102 or various data sources 225a-n. The data sources 225a-n may include a plurality of events 230a-n and 235a-n, for example. The experiment engine 210 may analyze the various input received via the interface 205 to identify an algorithm, parameter, and data set. The classifier 215 may classify information received from the data source 225a-n or the events 230a-n and 235a-n. The tool 120 may record information related to the experiment in database 220. The information may include an algorithm, parameter, data set, and an outcome of the experiment. The database 220 may also store a profile related to the experiment or the user of the tool, such as an algorithm developer.

The interface 205, experiment engine 210, and/or classifier 215 can comprise of the components in FIGS. 1A-1D. The components of the ETS tool 120, including, e.g., 205, 210, 215 and 220, may comprise an application, program, library, script, service, process, task or any other type and form of executable instructions executing on a client 102, a server 106 or cloud 108. The components of the tool 120 may interface with a plurality of modules, components, or systems of the tool 120 or via network 104 or in another way.

In further detail, the experiment tracking tool 120 may receive, via interface 205, data sets from data sources 225a-n. The data source 225 may be a third-party data vendor such as a financial instrument data vendor, a news archive vendor (e.g., Reuters or Bloomberg), historical weather or natural disaster archive, global weather data, etc. For example, a news outlet may provide a database that includes a time, title of a news article, and a location for a plurality of news articles published over a period of time.

In some embodiments, the data source 225 may provide a fixed data set that does not get updated. In other embodiments, the data source 225 may update the data set or provide up-to-date data (e.g., periodically, real-time, or responsive to an update). In still other embodiments, the data source 225 may be a streaming data source accessible via network 104. For example, the streaming data source 225 may include information related to an online social network (e.g., posts by users, user status updates, comments, user affinities to content, etc.). In another example, the streaming data source 225 may include up-to-the minute or real-time financial instrument data, such as current stock prices on a stock exchange. In some embodiments, the data source 225 or streaming data source may include various sensor data. For example, the data source 225 may include a global seismic sensor network that provides data that indicates seismic activity. In some embodiments, the data provided by data source 225 may include raw data, e.g., raw seismic readings or global weather data. In other embodiments, the data provided by data source 225 may include classified or quantized information such as, e.g., a news article headline indicating that an earthquake occurred in a region.

In some embodiments, the tool 120 receives data from one or more data sources 225a-n. For example, a first data source 225a may include financial instrument data, a second data source 225b may include news data, and a third data source 225c may include raw seismic data.

In some embodiments, the data set provided by each data source 225 may further include one or more events 230a-n. In some embodiments, the events may be pre-classified by the data source 225. For example, a data set that includes seismic data may indicate the day/time an earthquake occurred, the geographical location of the epicenter, and/or the magnitude of the earthquake. In other embodiments, the data source 225 may not explicitly indicate any events, but merely provide raw data to the tool 120, which can receive and analyze the data to identify one more events 230a-n, for example. In some embodiments, the data source 225 may not include any events; e.g., the raw seismic data may be for a period of time and/or location for which no earthquake occurred. In some embodiments, an event may indicate the absence of an event or the absence of an event for a certain time interval (e.g., a location and period of time during which no earthquake occurred).

In some embodiments, the data set provided by data source 225 may include data of varying granularity. For example, the data source 225 may include stock information on a per millisecond basis, or news articles on a per minute basis. In some embodiments, the tool 120 may receive data with a first level of granularity and interpolate or otherwise manipulate the data to create a second level of granularity. For example, the tool may interpolate a data set that includes stock price on a per second basis to generate a data set with stock prices on a millisecond basis.

In some embodiments, the tool 120 may crawl and parse a plurality of online data sources. For example, the tool 120 may crawl and parse various web sites relating to products, entertainment, travel, weather or social networking web sites.

The data sources 225a-n may comprise any type of database residing on a storage, memory or server. The data sources 225a-n may further comprise an application, program, library, script, service, process, task or any type and form of executable instructions executing on a client 102, server 106 or cloud 108. The data sources 225a-n may interface with the tool 120 via network 104 or in any other way.

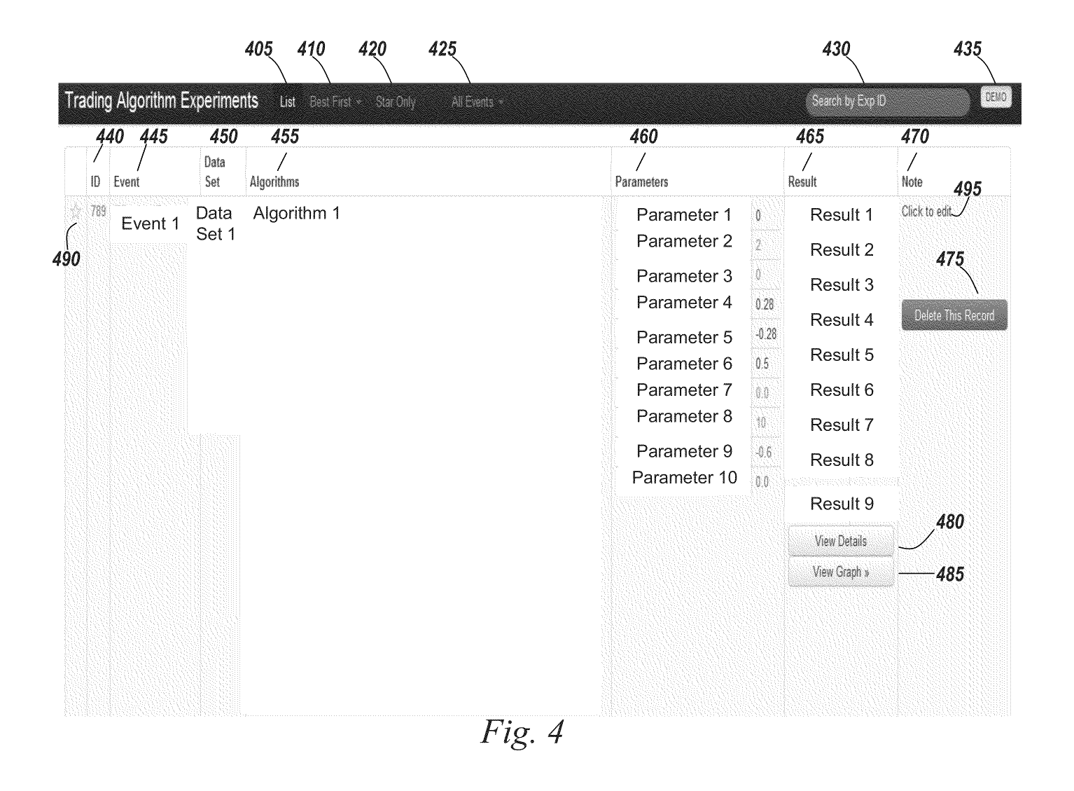

In some embodiments, the tool 120 includes an interface 205 designed and constructed to receive user input and data input. The user interface may present and provide access to the functionality, operations and services of the experiment tracking tool 120. To implement the functionality of the tool, the interface may include any number of user interface components generally referred to as widgets. A widget may comprise any one or more elements of a user interface which may be actionable or changeable by the user and/or which may convey information or content. For example, a widget may be an input text box, dropdown menu, button, file selection, etc. Interface widgets may comprise any type and form of executable instructions that may be executable in one or more environments. Each widget may be designed and constructed to execute or operate in association with an application and/or within a web-page displayed by a browser. One or more widgets may operate together to form any element of the interface, such as a dashboard. The user interface may include any embodiments of the user interfaces described in FIG. 4 or any portions thereof or functionality provided by such user interfaces.

The tool 120 may require some user input to track an experiment, while other input may be optional. For example, a required user input may be an event identifier, algorithm or a parameter, while the tool may automatically obtain one or more data sets from data sources 225. For example, if the event identifier is a hurricane, the tool may automatically obtain a data set that includes weather data. In some embodiments, the tool may prompt the user for input using one or more widget described herein.

In some embodiments, the tool 120 includes an experiment engine 210 designed and constructed to execute an experiment to produce an outcome. The experiment engine 210 may execute a set of experiments that includes a plurality of experiments to produce an outcome for each of the plurality of experiments of the set of experiments. Executing an experiment may comprise executing a script, application, or any other executable instruction that provides an outcome based on an algorithm, a parameter, and a data set.

In some embodiments, the experiment engine 210 may identify an algorithm, one or more parameters, and one or more data sets for an experiment. The experiment engine 210 may automatically identify the algorithm, parameters and data sets. For example, the experiment engine 210 may identify a certain block of programming code or executable instructions as being an algorithm, and further identify one or more parameter of the algorithm. In some embodiments, an algorithm developer may indicate in their program script or code that one or more lines, functions, files, or programs includes the algorithm. The algorithm developer may further indicate one or more parameters of the algorithm. In some embodiments, an algorithm developer may indicate, via interface 205, the algorithm, parameter or data set.

Upon obtaining a first data set, the experiment engine 210 may identify a first set of one or more events of the first data set. In some embodiments, the experiment engine 210 may obtain a second data set and identify a second set of one or more events of the second data set. In some embodiments, the experiment engine 210 identifies events of a data set by parsing the text of a data set. For example, in a news data set, the experiment engine may crawl or parse the news headlines of the news data set to identify a keyword match between a predetermined one of more keywords that indicates an event. In some embodiments, the experiment engine 210 may be configured to perform semantic analysis techniques to identify a semantic concept of the data set. A semantic concept may be any topic or concept, such as news, weather, travel, entertainment. The granularity of semantic concepts may vary, and include concepts such as bad weather, hurricanes, hurricanes in North America, hurricanes in the Gulf Coast, hurricanes in the Gulf Coast in the last five years, etc.

The experiment engine 210 may correlate events in a first data set with one or more events in a second data set. For example, given an event identifier of hurricane, the tool may identify all events of a data set that are correlated with the hurricane event type, such as, e.g., oil prices, electricity usage, water usage, television viewership, online traffic, transportation traffic, stock prices, etc. The tool 120 may correlate events based on a classification identifier, assigned to the event by a classifier 215, and a time. The experiment engine 210 may determine that an occurrence of event type A in the first data set corresponds to an event type B in the second data set. The experiment engine 210 may further determine that an occurrence of event type A in the first date set results in a likelihood that event type B occurred in the second data set at a corresponding time or within a certain range of time (e.g., within 10 seconds, 20 seconds, 30 seconds, 1 minute, 5 minutes, etc.). The optimal time range may be a parameter of the experiment or may be automatically determined by the experiment engine 210 based on a parameter. For example, a parameter may indicate the minimum likelihood that an occurrence of event type A in the first data set results in an occurrence of event type B in the second data set within a time range. The threshold may set a minimum likelihood of occurrence between 0% and 99.99%, such as 10%, 20%, 75%, 80%, 90%, 95%, 99%, 99.9% or any other percentage. For example, if the parameter is 95%, the experiment engine 210 may determine that there is a 95% probability that an occurrence of event type A in the first data set resulted in an occurrence of event type B within two minutes of an occurrence of event type A.

In some embodiments, the tool 120 determines a correlation based on a frequency of events. The experiment engine 215 may determine that a high frequency of event type A in the first data set is followed by a high frequency of event type B in the second data set. For example, a high frequency of keywords within a duration of time in a social network data set may correlate with a high frequency of purchase or sell orders in a financial instrument data set. In another example, a high frequency of news headlines containing a keyword in a news data set may correlate with a severity (e.g., magnitude, casualty, damages, etc.) of an event in a seismic sensor data set.

In some embodiments, the experiment engine 210 may further correlate events in a first data set with events in a second data set based on a geographical location. For example, an event may include a classification identifier, time, and geographic location (e.g., latitude and longitude, continent, country, state, county, city, town, etc.). The experiment engine 210 may determine that one or more events in the first data corresponding to a first geographic location correspond to one or more events in a second data set corresponding to a second geographic location. In some embodiments, the first and second geographic location may be the same or within a close proximity (e.g., within 10 miles, 20 miles, etc.). In some embodiments, the first and second geographic locations may be different; e.g., there may be no close physical proximity between the first and second geographic locations. For example, an event type A of a first data set corresponding to a geographic location in China may be correlated with an event type B of second data corresponding to a geographic location in California.

In some embodiments, the tool 120 executes an experiment with a portion of a data set obtained from data source 225. For example, the data source 225 may include data for the last 100 years. The tool 120 may select data for some subset of the last 100 years, e.g., the last 10 years. In some embodiments, the tool 120 may automatically select a subset of data. In other example, the tool 120 may receive an indication about the amount of the data to select for executing the experiment.

In some embodiments, the experiment engine 210 executes a set of experiments within a predetermined time. In some embodiments, the tool 120 may use an amount of data in the data set such that the tool can complete running all experiments within the predetermined time. For example, the data set may include data for the past 10 years. The tool 120 may determine that the time to execute an experiment on one year of data is 30 seconds. The tool 120 may determine the time to execute an experiment or set of experiments based on one or more of the complexity of the algorithm and parameters, the number of experiments, the number of data entries in the data set, and the processing power of the tool. In some embodiments, the tool 120 may limit the amount of data used to execute the experiment based on the predetermined time limit; e.g., if the predetermined time limit is five minutes, and the tool 120 determines that the time to run the set of experiments on one year of data is 30 seconds, the tool 120 may execute the experiment on ten years of data.

In another embodiment, the tool 120 may limit the number of experiments in the set of experiments to execute the experiment in a predetermined time period. In yet another embodiment, the tool 120 may obtain additional resources via network 104 or cloud 108, such as clients 102 and servers 106, to execute the set of experiments within the predetermine time period.

In some embodiments, the experiment engine 210 executes at least two or more of the plurality of experiments of the set of experiments concurrently. The tool 120 may employ multi-processing and/or multi-threading techniques to concurrently execute experiments. For example, the tool 120 may include or utilize multicore or multi-threaded processors configured to concurrently execute experiments. In some embodiments, the tool 120 may identify resources via network 104 and cloud 108, such as clients 102 and servers 106, configured to execute one or more experiment of the set of experiments.

The tool 120 may execute multiple sets of experiments to identify differences in sets of experiments or between each of the plurality of experiments of each set of experiment. For example, the tool may execute a first set of experiments that includes a first plurality of experiments that each have the same algorithm and data sets, but different parameter values. The tool 120 may execute a second set of experiments that includes a second plurality of experiments that each have the same algorithm and parameters as in the first plurality of experiments, but include a different data set. In this example, the tool 120 may identify a first optimal experiment within the first set of experiments. The tool 120 may further identify a second optimal experiment within the second set of experiments. The tool 120 may further identify an optimal experiment between the first optimal experiment and the second optimal experiment. In some embodiments, the first and second optimal experiment may include the same algorithm and parameters, thus showing that the algorithm and parameter combination performs well with both data sets. In another embodiment, the first optimal outcome and the second optimal outcome may correspond to different parameters, thus showing that the algorithm and parameter selection is dependent on the data set. An algorithm developer may be satisfied with this difference or choose to run further experiments with the goal of identifying a set of parameters and algorithms that provide optimal outcomes for both the first data set and the second data set.

In some embodiments, the tool 120 selects at least one of the algorithm and one or more parameters corresponding to one or more experiments of the set of experiments. The tool 120 may make the selection by determining the experiment with the optimal outcome. In other embodiments, the tool 120 may select the experiment with the fastest execution time, the fewest number of parameters, or based on a combination of factors. For example, the tool 120 may identify that three experiments of the set of experiments resulted in an outcome above a predetermined threshold. The tool 120 may then select one experiment out of the three experiments based on the fastest run time and/or the fewest number of parameters.

In some embodiments, the tool 120 may output to a display, via a user interface, one or more aspect of the experiments. The tool 120 may output an aspect of the data set, algorithms, parameters, and/or outcomes. The tool 120 may concurrently output information corresponding to one or more experiments or all experiments of a set of experiments. The tool 120 may also concurrently output information corresponding to multiple sets of experiments.

In some embodiments, the tool 120 may re-execute an experiment or a set of experiments to produce an outcome. In some embodiments, the algorithm developer or user of the tool may vary one or more parameters of the experiment to create an additional experiment, and then re-run the new experiment with the original experiment to test the affect of the changes on the outcome of the experiment.

The tool 120 may identify differences between the first instance of executing the experiments and the second instance of executing the differences. In some examples, the outcomes between the first instance and second instance may be the same. In other examples, the outcomes between the first instance and the second instance may be different, even though the algorithm, parameters and data sets remain largely unchanged. For example, there may be unintended changes in tool 120 or data source 225 that may alter an outcome. Thus, in some embodiments, the tool 120 may re-execute a prior experiment and compare the outcome with the first instance of the experiment to verify that the experiment environment is operating as expected. If there is a difference in one or more experiment of the set of experiments between the first instance of execution and the second instance, the tool 120 may identify the differences. The tool 120 may prompt an algorithm developer or user of the tool 120 to isolate and resolve the differences. The tool 120 may facilitate the resolution of the differences by identifying the one or more experiment, parameter, algorithm, data source that may have changed between instances of the experiment.

In some embodiments, the tool 120 includes a classifier 215 designed and constructed to classify an event of a data set. The classification may occur in real-time, i.e., at the time of execution of the experiment or applying the algorithm. In other embodiments, the classification information may be stored in database 220. The classifier 215 may classify the event based on the data set by identifying keyword matches, semantic concept matches, metrics that over a threshold, or another classification schema or technique. Upon classifying an event, the classifier 215 may assign a classification identifier to the event and record the classification identifier along with other information about the event, including, e.g., time or geographic location, in an electronic record stored in the database 220. The classification identifier may comprise any combination of letters, numbers, symbols, or other characters. In some embodiments, the classifier 215 may assign a unique identifier to the event. In some embodiments, the classification identifier may indicate an attribute or other qualitative or quantitative aspect of the event. For example, the classifier 215 may analyze a data set comprising raw seismic data to identify an earthquake event, and assign a corresponding classification identifier. The classifier 215 may assign a classification identifier to the event that indicates, for example, a type of event and a severity of the event.

In some embodiments, the classifier 215 may analyze textual content of a data set to classify events. For example, the classifier 215 may analyze events in a news data set and classify events as political news, weather news, business news, sports news, economy news, international news, etc. Classifications may including various granularity; e.g., weather news may include classification identifier indicating types of weather, severity of each type of weather, geographic indications, casualty rate, cost of damages, etc.

In some embodiments, the classifier 215 may classify events or an aspect of an event of a social network data set. For example, an event of a social network data set may be similar to an event of a news data set in that an event of the social data set may include the news event; e.g., users of the social network may indicate, via posts or other online input, that a current event, weather event, or any other event has occurred. The classifier 215 may classify or quantify the event based on a frequency of the social network textual posts, the quality of the posts, the length of the posts, the geographic location of the post, or any other factors. For example, the an event of a social network data set may indicate the launch of a new consumer electronics product. The classifier 215 may assign a classification identifier that indicates one or more of the event is a business related event, consumer electronics business related event, consumer electronics product launch, cell phone product launch, geographic location of product launch, etc. The classifier 215 may also assign a classification identifier that quantifies the event. For example, the quantifying classification identifier may indicate a high frequency of posts in a short period of time, which may indicate a high level of interest in the event. In some embodiments, the classifier 215 may parse the posts for one or more keywords that indicates a qualitative aspect of the event; e.g., the social network data may indicate positive, negative, or neutral reactions to the event.

Using the classification identifier and a time of an event, the tool 120 may quantify one or more events. In some embodiments, a quantification may include the classification identifier and an event time. For example, the classification identifier may indicate the type event and additional information about the event, such as, e.g., a magnitude, severity, frequency, affinity, or any other attribute or characteristic of the event. In other embodiments, quantifying the event may include an additional quantification index that indicates, e.g., a magnitude, severity, frequency, affinity or other attribute or characteristic of the event.

The classifier 215 may comprise an application, program, library, script, service, process, task or any type and form of executable instructions executing on a client 102, server 106 or cloud 108. The classifier 215 may interface with a plurality of modules, components, or systems via network 104 or in any other way.

In some embodiments, the tool 120 includes a database 220 designed and constructed to store information related to the tracking experiments. The database 220 may be configured to receive information from the interface 205, experiment engine 210, classifier 215 or any other component or module. The tool 120 may record information associated with each run of the experiment in an electronic record stored in database 220. The recorded information stored in database 220 may include the various algorithms, parameters, data sets and outcomes of each experiment of the set of experiments. In some embodiments, the database 220 may assign a unique identifier to each algorithm, parameter, data set and outcome. The database 220 may store the data such that the data corresponds to an experiment or run of an experiment.

In some embodiments, the database 220 may store profile information. Profile information may correspond to a experiment environment. For example, a profile may indicate one or more algorithms, parameters and data sets to use for an experiment. The profile may indicate a subset of data to use for the experiment, the number of times to execute an experiment, or the number of experiments to execute simultaneously. The profile may also indicate a format for outputting information to a display via the user interface.

In some embodiments, the tool may receive textual annotations related to one or more aspect of an experiment or set of experiments. For example, the developer may enter notes associated with a data set, parameter, or algorithm that may facilitate algorithm development. In some embodiment, the tool may prompt a user of the tool to input information.

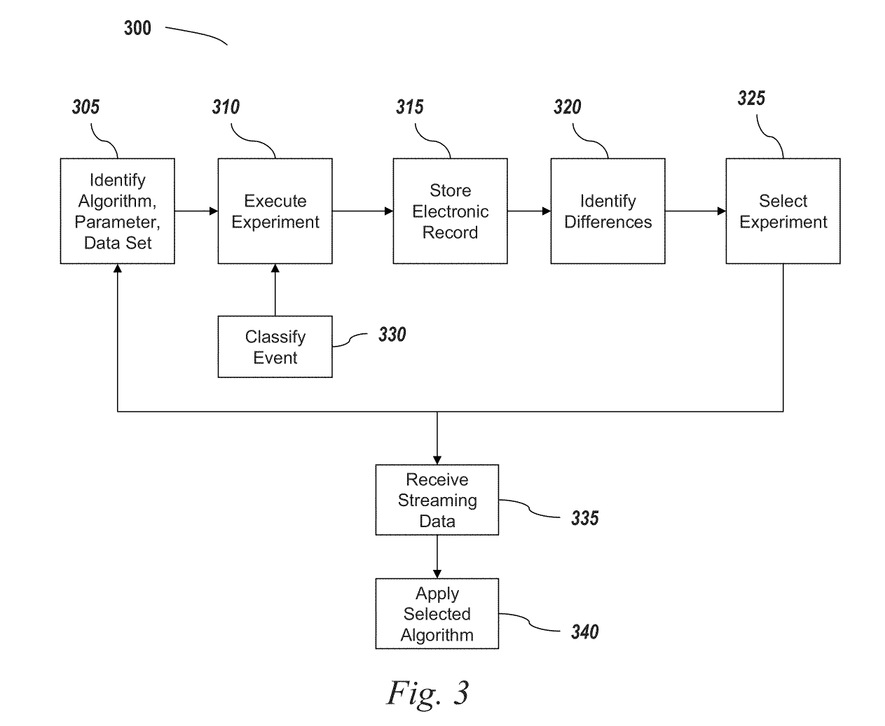

Referring now to FIG. 3, embodiments of a method for tracking experiments is depicted. In brief overview, at step 305, an experiment tracker may identify information such as an algorithm, parameter or data set of an experiment. At step 310, the experiment tracker use the identified information to execute an experiment. In some embodiments, at step 330, the experiment tracker may classify an event of the data set. At step 315, the experiment tracker stores information about the experiment in an electronic record. The information may include an algorithm, parameter, data set or outcome of the experiment. At step 320, the experiment tracker may identify differences between two or more experiments. At step 325, the experiment tracker may select an experiment or receive an indication from a user to select an experiment. In some embodiments, at step 335, the experiment tracker may receive streaming data via a network. At step 340, the experiment tracker may apply an aspect of the experiment selected at step 325 to the streaming data.

In an illustrative example, the tool may facilitate developing an algorithm and applying the algorithm in real-time to streaming data. For example, the tool may identify an algorithm, parameter or data set of a plurality of experiments and execute the plurality of experiments. The tool may then select, or facilitate a user to select, an experiment of the plurality of experiments that produced an optimal or desired result. Upon selecting an experiment, or receiving a selection of an experiment of the plurality of experiments, the tool may identify the algorithm, parameters, and data set that corresponds to the selected experiment. The tool may then receive streaming data from a network and apply the selected algorithm in real-time. In some embodiments, the tool may identify a type of streaming data that corresponds to the data set of the experiment that produced the optimal or desired result.

In further detail, at step 305 a tool may identify one or more algorithms, parameters and/or data sets corresponding to an experiment or a set of experiments. The tool may receive the algorithm and parameters from a database, client device or server via a network. In some embodiments, the tool may identify the algorithms, parameters, data sets by prompting a user of the tool for input that indicates an algorithm, parameter or data set. For example, the tool may prompt a user to input an algorithm, in which case the tool may identify the input as an algorithm.

In some embodiments, at step 305 the tool may automatically identify an algorithm, parameter and/or data set. The tool may determine that one or more functions, program files, API's, or other elements of a program is an algorithm. The tool may further identify, based on the algorithm, one or more parameters. For example, the algorithm may include various thresholds, outcomes, or other variables that may comprise one or more parameters.

In some embodiments, the tool may identify a data set of a data source (step 305). In some embodiments, the tool may identify a subset of the data set. For example, the data set may include 10 years worth of data. The tool may identify the most recent 3 years or may identify the most volatile or most steady years, for example. The stool may further identify a subset of the data based on a second data set. For example, a second data set may include a plurality of events that occur within a time range or at various times. The tool may identify the times of events in the second data set to identify a corresponding subset of data of the first data set.

At step 310, the tool may execute an experiment to produce an outcome. In some embodiments, at step 310 the tool may execute one or more experiments of a set of experiments to produce an outcome for each of the one or more experiments. Executing the experiment may include executing a program, script, application or other manner of executing computer executable instructions that includes an algorithm, parameter and data set to produce an outcome.

In some embodiments, the tool may execute an experiment based on an algorithm, parameter and data set to produce an outcome (step 310). In some embodiments, the tool may execute the experiment based on a first data set that includes a first set of events and a second data set that includes a second set of events. In some embodiments, the tool may execute the experiment based on a subset of the first data set and/or the second data set.

At step 330, the tool may classify an event from a data set. The tool may classify an event based on one or more criteria that indicates at least one of a type of an event, a quantification of an event, a frequency of an event, or another aspect of an event. For example, at step 330 the tool may identify seismic readings that indicate an earthquake. The tool may classify the event as an earthquake and assign to the event a location and/or time or time interval. The tool may further classify the event as mild, moderate, severe or use another quantification indicator (e.g., color schemes, numerical ranges, letter/number combination, symbols, characters, etc.). The tool may classify the event based on one or more metrics that indicate a quantification or severity of the event (e.g., numerical earthquake magnitude values, numerical damage costs, number of deaths/injuries, duration of power loss, etc.). In some embodiments, the tool may, at step 330, assign a quantification based on a plurality of quantification metrics.

At step 320, the tool may identify the differences between two or more experiments or between two or more sets of experiments. Differences may include a difference in one or more of the algorithm, parameter, data set and outcome. For example, a first experiment may use parameters A, B, C and the second experiment may use parameters A, C, and D. The tool may highlight parameter D as the difference or further indicate that the second experiment does not use parameter B.

In some embodiments, the tool may identify differences in algorithms by comparing the code, functions, or scripts included in the algorithm (step 320). In some embodiments, the tool may compare an algorithm identifier to identify a difference in algorithms. For example, a first algorithm may include an algorithm identifier A1 and a second algorithm may include an algorithm identifier A2. In some embodiments, an algorithm may include a plurality of algorithms, in which case the tool may identify the differences in algorithms between two or more experiments. For example, a first experiment may include algorithms A1, A2, and A3 and a second experiment may include algorithms A1, A3, and A4. The tool may identify that A2 and A4 are different. In some embodiments, the tool may identify the order of the execution of the algorithms as being different. For example, the first experiment may execute A1, A2, and A3 whereas the second experiment may execute A1, A3, A2. The difference in order may or may not result in a different outcome or increased efficiencies.

At step 325, an experiment may be selected. In some embodiments, the tool automatically selects an optimal experiment based on predetermined threshold. In some embodiments, the tool may receive an indication of an optimal experiment from an algorithm developer or user of the tool via a user interface.

The tool may automatically select an experiment based on an optimal outcome. For example, an algorithm that identifies that strongest correlation between an event in a first data set and an event in a second data set may result in the best outcome. In another example, an algorithm that identifies an event in a first data set that maximizes a return on investment in a second data set may result in the best outcome. For example, the algorithm may identify that an earthquake with a 6.0 magnitude occurring in California results in the largest decrease in the price of stock for companies in the agriculture industry. In this example, the threshold for a correlation metric may indicate a 95% correlation and a price change may indicate a minimum 10% change in stock price.

In some embodiments, the tool may receive a selection of an experiment and further receive a change in a parameter, algorithm, and data set. The tool may re-execute the experiment or set of experiments with the updated parameter, algorithm, or data set.

Upon selection of an experiment, the tool may identify or store one or more optimal algorithm, parameter and data set corresponding to the experiment. The tool may apply the selected algorithm and parameters to a current data to identify an event in real-time or make a decision in real-time. For example, if the tool identifies, at step 325, that event type A of a first data set is highly correlated with event type B of a second data set, then at step 335 the tool may receive streaming data corresponding to the first data set. At step 340, the tool may apply an aspect of the selected algorithm to the streaming data set to identify event type A and also indicate that event type B is likely to occur. The tool may apply a further aspect of the algorithm or related algorithm based on the likely occurrence of event type B.

Referring again to the stock trading example, the tool may identify that a certain type of earthquake in a certain region may influence a stock price for companies in a certain industry, geography, or even specific companies. The tool, at step 335, may receive raw seismic data from a real-time global seismic sensor network and identify, in real time, whether an earthquake has occurred and its epicenter. Upon identifying an event type A earthquake at step 340, the algorithm may determine that event type B is likely to occur imminently. In this example, event type B may be the increase in stock price of agricultural companies that grow a certain crop proximate to a certain latitude and longitude coordinate. The tool may further cause the purchase of one or more shares of stock corresponding to event type B in an attempt to purchase the stock before its likely increase.

Referring now to FIG. 4, an illustration of some embodiments of a graphical user interface of systems and methods of tracking experiments is shown. Embodiments of the graphical user interface include buttons representing views for the experiment, including, e.g., a list view 405, best first view 410, star only view 415 and an all events view 425. In the list view, the tool may output the experiments and corresponding data as a list. In icon view, the tool may output the experiments as an icon, that a user may then select to view additional information.

Selecting the Best First 410 button may rank the experiments by best performing experiments to worst performing experiments. For example, experiments that resulted in the best outcome (e.g., highest correlation between events, or desired events, or any other predetermined desired result) may be ranked first. In another example, experiments that ran the fastest while achieving an outcome above a threshold may be ranked as the best. In another example, experiments that used the least amount of data in a data set while producing an outcome above a certain threshold may be ranked as the best performing experiment.

In some embodiments, the tool may rank aspects of an experiments. The tool may rank the best parameters and results of a specific experiment. For example, an experiment may include one data set and one algorithm. The algorithm may include ten parameters that provide nine results. The tool may rank the best performing results of the experiments. In the stock trading example, the correlation outcome may be very high and the price change may be low or insignificant. Since the price change is insignificant, it may not be worth the risk to purchase the stock.

A user may indicate than an experiment is important by selecting the star 490. The user may then display starred experiments or data by selecting the star only button 420 of the tool.

The user may alternatively display all events by selecting the all events button 425. The all events button 425 may be a drop down menu with additional view options, such as, e.g., all algorithms, all data sets, all parameters, all results, and/or all notes.

The tool may display an identifier (“ID”) 440 for the experiment in a column of the graphical user interface. The ID may be a unique identifier of an experiment. The ID may be increment as additional experiments are added/generated by the tool. The ID of the experiment may be stored in the database. The tool may display an event 445, a data set 450, and algorithm 455. The event may indicate an event type corresponding to the data set. Some experiments may include multiple events, multiple data sets, or multiple algorithms.

The tool may display a plurality of parameters 460 and results 465. The tool may highlight certain parameters and results as being positive or negative (i.e., good or bad results) based on a predetermined threshold. The tool may also indicate differences between two or more experiments by changing the color of the font.

A user may select view details 480 to view additional details corresponding to the results of the experiment. Additional details may include additional results, time to executions, or any other output from executing the experiment or information about the experiment. A user may view a graph of the results by selecting View Graph 485. In some embodiments, upon selecting view graph 485, the tool may prompt the user for data to graph. In other embodiments, the tool may automatically graph data corresponding to the experiment or set of experiments. The tool may generate one or more graphs based on a user profile stored in the database.

The user may annotate one or more aspect of the experiment by selecting the “click to edit” button 495. In some embodiments, the textual note may correspond to the set of experiments, an individual experiment, a parameter, result, data set, or algorithm of the experiment. The user may delete the textual note by selecting the “delete this record” button 475.

In some embodiments, a user of the tool may search for an experiment using a search bar 430. The tool may include a demo button 435 that initiates a demonstration mode for the tool. Under demonstration mode, the tool may redact or censor information about the experiment, including, e.g., the event 445, data set 450, algorithms 455, parameters 460, results 465 or notes 470. For example, during a demonstration, it may be confusing or distracting to display the textual notes 470. In another example, the algorithm developer may not wish to disclose an algorithm 455 during a demonstration. The tool may further require a password or other authentication measures to enable or disable demonstration mode.

While the invention has been particularly shown and described with reference to specific embodiments, it should be understood by those skilled in the art that various changes in form and detail may be made therein without departing from the spirit and scope of the invention described in this disclosure.

What is claimed:

1. A method for tracking a set of experiments comprising:
a) identifying, by a tool executing on a device, an algorithm and one or more parameters for each of a plurality of experiments of a set of experiments to be executed, the set of experiments to identify a correlation between a first set of one or more events of a first data set and a second set of one or more events of a second data set;
b) executing, by the tool, the set of experiments to produce an outcome for each of the plurality of experiments;
c) storing, by the tool, an electronic record of the execution of the set of experiments, the electronic record comprising at least one of the algorithm, the one or more parameters, the first data set, the second data set, and the outcome; and
d) identifying, by the tool, one or more differences between the plurality of experiments.

2. The method of claim 1, wherein step (b) further comprises executing the set of experiments within a predetermined time period.

3. The method of claim 1, wherein step (b) further comprises executing at least two or more of the plurality of experiments concurrently.

4. The method of claim 1, wherein step (b) further comprises determining a level of correlation based on a classification identifier, a frequency of events, and an event time.

5. The method of claim 1, further comprising:
executing, by the tool, a second set of experiments to produce one or more outcomes for each of a second plurality of experiments of the second set of experiments; and
identifying, by the tool, one or more differences between the first set of experiments and the second set of experiments.

6. The method of claim 1, wherein:
step (a) further comprises selecting a first subset of the first data set and a second subset of the second data set; and
step (b) further comprises executing the set of experiments based on the first and second subsets.

7. The method of claim 1, wherein step (b) further comprises:
quantifying at least one of the first set of one or more events and at least one of the second set of one or more events, the quantification comprising a classification identifier and an event time.

8. The method of claim 1, wherein step (b) further comprises:
determining, by the tool, based on at least one of the first and second data sets, at least one of a keyword match, semantic concept, or metric; and
assigning, by the tool, a classification identifier to at least one of the one or more events corresponding to the determination.

9. The method of claim 1, further comprising:
e) selecting, by the tool, based on an outcome threshold, at least one of the algorithm and one or more parameters corresponding to one of the plurality of experiments; and
f) executing, by the tool, a second set of experiments comprising at least one of the selected algorithm and the selected one or more parameters.

10. The method of claim 1, wherein at least one of the first data set and the second data set comprises streaming data, the streaming data comprising at least one of:
online social network data;
financial instrument data;
news data;
sensor data; and
weather data.

11. The method of claim 1, further comprising:
e) receiving, by a user interface of the tool, an annotation corresponding to at least one of the plurality of experiments; and
f) storing, by the tool, the annotation in the electronic record.

12. A system for tracking a set of experiments comprising:
a tool executing on a device that identifies an algorithm and one or more parameters for each of a plurality of experiments of a set of experiments to be executed, the set of experiments to identify a correlation between a first set of one or more events of a first data set and a second set of one or more events of a second data set, and executes the set of experiments to produce an outcome for each of the plurality of experiments; and
a database that stores an electronic record of the execution of the set of experiments, the electronic record comprising at least one of the algorithm, the one or more parameters, the first data set, the second data set, and the outcome;
and wherein the tool identifies one or more differences between the plurality of experiments.

13. The system of claim 12, wherein the tool executes the set of experiments within a predetermined time period.

14. The system of claim 12, wherein the tool executes at least two or more of the plurality of experiments concurrently.

15. The system of claim 12, wherein the tool determines a level of correlation based on a classification identifier, a frequency of events, and an event time.

16. The system of claim 12, wherein the tool executes a second set of experiments to produce one or more outcomes for each of a second plurality of experiments of the second set of experiments, and identifies one or more differences between the first set of experiments and the second set of experiments.

17. The system of claim 12, wherein the tool selects a first subset of the first data set and a second subset of the second data set, and executes the set of experiments based on the first and second subsets.

18. The system of claim 12, wherein the tool quantifies at least one of the first set of one or more events and at least one of the second set of one or more events, the quantification comprising a classification identifier and an event time.

19. The system of claim 12, wherein the tool determines, based on at least one of the first and second data sets, at least one of a keyword match, semantic concept, or metric, and assigns a classification identifier to at least one of the one or more events corresponding to the determination.

20. The system of claim 12, wherein the tool selects, based on an outcome threshold, at least one of the algorithm and one or more parameters corresponding to one of the plurality of experiments, and executes a second set of experiments comprising at least one of the selected algorithm and the selected one or more parameters.
